(19) United States
(12) Patent Application Publication
(10) Pub. No.: US 2025/0058833 A1
(43) Pub. Date: Feb. 20, 2025

(54) Front structure for an automotive vehicle

(71) Applicant: ArcelorMittal, Luxembourg (LU)

(72) Inventors: Gagan TANDON, Canton, MI (US); Nimish DESHPANDE, Detroit, MI (US); Nachiket GOKHALE, Royal Oak, MI (US)

(21) Appl. No.: 18/728,099

(22) PCT Filed: Jan. 20, 2023
(86) PCT No.: PCT/IB2023/050503

§ 371 Date: Jul. 11, 2024

(30) Foreign Application Priority Data
Jan. 27, 2022 (WO) PCT/IB2022/050720

(51) Int. Cl. B62D 25/14; B21D 22/02

(52) U.S. Cl. CPC B62D 25/14; B21D 22/022

(57) ABSTRACT

Front member assembly (1) for an automotive vehicle including an upper shell (11) and a lower shell (12), wherein the upper and lower shells (11, 12) each include a right, left and transverse portion and wherein the upper and lower shells are assembled together by attaching them at least along upper and lower contours (1121, 1122, 1221, 1222, 1131, 1132, 1231, 1232) of the right and left portions.

### BACKGROUND

Car makers are submitted to the ever more demanding requirements of increasing the passive safety of vehicles, lowering the weight of the vehicle to minimize greenhouse gas emissions in case of internal combustion engines or increase the vehicle's driving range in case of electric vehicles, while keeping production costs low and productivity rates high.

### SUMMARY OF THE INVENTION

The front members and dash panel reinforcements form a key structural component of a motor vehicle which contributes to the safety of the occupants in case of a front crash. The front members pick up the crash energy transmitted by the bumper beam through the front crash boxes and act to absorb part of said energy, to protect the front occupants of the vehicle and to transmit the energy to the rest of the vehicle structure. The dash panel cross members act to further prevent intrusion in the passenger compartment and to distribute the energy between the two sides of the vehicle structure so that they efficiently cooperate. The front members and dash panel cross members are of particular importance when managing a front crash with an offset, i.e. during which only part of the front of the vehicle is impacted. Indeed, the front members are located on the sides of the vehicle and will be strongly solicitated in case of an offset impact. Such impacts are known to occur frequently in real life collisions and are the object of several safety rating tests such as the Insurance Institute for Highway Safety's (IIHS) Small Overlap Rigid Barrier (SORB) crash, in which a vehicle is impacted with only 25% overlap in the width by a rigid barrier moving at 64.4 km/h.

Furthermore, the front energy absorption and anti-intrusion structure of a vehicle is of particular importance when designing automotive vehicles which are free of a front combustion engine. This is for example the case of electric vehicles, fuel cell vehicles or vehicles having their engine in the rear. Indeed, a front combustion engine absorbs part of the energy in the case of a front impact but also needs to be dropped out of the load path in order to protect the occupants. The absence of front combustion engine calls for new ways of designing the front crash management system.

It is an object of the present invention to provide a design and an assembly method for a front member assembly having a very high crash management efficiency. Such a design can advantageously be used in vehicles having no front combustion engine. It is also an object of the present invention to provide a vehicle with a front member assembly according to the invention.

It is also an object of the current invention to provide a front member assembly having a lower weight than the current design, thereby saving fuel in the case of combustion engines and increasing driving range in the case of electric engines driven vehicles.

Furthermore, it is an object of the present invention to address the challenges of increasing productivity, diminishing complexity and diminishing costs in vehicle production. Indeed, the current invention provides a front member assembly having fewer parts than the reference designs. The inventive design can be produced and assembled in very few manufacturing steps compared to the reference. On top of simplifying production, diminishing the number of production steps also diminishes the environmental footprint of the production process and diminishes overall CO2 emissions when manufacturing the vehicle.

The present invention provides a front member assembly (1) for an automotive vehicle comprising an upper shell (11) and a lower shell (12), each comprising respectively a right portion (112, 122) and a left portion (113, 123) extending substantially in a longitudinal direction, each of said right and left portions being linked together by a transverse portion (114, 124) extending substantially in a transverse direction between attachment points located at the rear of said left and right portions, said upper and lower right portions (112, 122) defining together a right hollow volume (20), said upper and lower left portions (113, 123) defining together a left hollow volume (30), said right and left hollow volumes (20, 30) extending from the front of the right and left portions to the attachment point of said right and left portions with their respective transverse portions (114, 124), said upper right and left portions (112, 113) being delimited by a lower contour inner and outer (1121, 1122, 1131, 1132), said lower right and left portions (122, 123) being delimited by an upper contour inner and outer (1221, 1222, 1231, 1232), wherein said upper and lower shells (11, 12) are assembled together by attaching them at least along part of said corresponding lower and upper contours. A further object of the present invention is achieved by providing an automotive vehicle comprising the above front member assembly.

In the following descriptions and claims, the directional terms are defined according to the usual directions of a mounted vehicle.

In particular, the terms “top”, “up”, “upper”, “above”, “bottom”, “low”, “lower”, “below” etc. are defined according to the elevation direction of a vehicle. The terms “front”, “back”, “rear”, “front”, “forward”, backward” etc. are defined according to the longitudinal direction of a vehicle, i.e. the direction in which the vehicle moves when following a straight line. The terms “left”, “right”, “transverse”, etc. are defined according to the orientation parallel to the width of the vehicle. The terms “inner”, “outer” are to be understood according to the width direction of the vehicle: the “inner” is closest to the central axis of the vehicle, i.e. closest to the inside of the vehicle, whereas the “outer” is located further away from said central axis of the vehicle, in effect closer to the outside of the vehicle. The term “horizontal” refers to the orientation of the plane comprising the longitudinal and the transverse directions. The term “vertical” refers to any orientation comprising the elevation direction.

In the following figures, the orientations and spatial references are all made using an X, Y, Z coordinates referential, wherein Z is the elevation direction of the vehicle, X is the longitudinal direction of the vehicle and Y is the transverse direction of the vehicle. The referential is represented in each figure. When the figure is a 2D flat representation, the axis which is outside of the figure is represented by a dot in a circle when it is pointing towards the reader and by a cross in a circle when it is pointing away from the reader, following established conventions.

By “substantially parallel” or “substantially perpendicular” it is meant a direction which can deviate from the parallel or perpendicular direction by no more than 15°.

A steel sheet refers to a flat sheet of steel. It has a top and bottom face, which are also referred to as a top and bottom side or as a top and bottom surface. The distance between said faces is designated as the thickness of the sheet. The thickness can be measured for example using a micrometer, the spindle and anvil of which are placed on the top and bottom faces. In a similar way, the thickness can also be measured on a formed part.

By average thickness of a part, or of a portion of a part, it is meant the overall average thickness of the material making up the part after it has been formed into a 3-dimensional part from an initially flat sheet.

Tailor welded blanks are made by assembling together, for example by laser welding together, several sheets or cut-out blanks of steel, known as sub-blanks, in order to optimize the performance of the part in its different areas, to reduce overall part weight and to reduce overall part cost. The sub-blanks forming the tailor welded blanks can be assembled with or without overlap, for example they can be laser butt-welded (no overlap), or they can be spot-welded to one another (with overlap).

By opposition to a tailor welded blank, a monolithic blank refers to a blank which consists of one single sub-blank, without several sub-blanks being combined together.

A tailor rolled blank is a blank having multiple sheet thicknesses obtained by differential rolling during the steel sheet production process.

The ultimate tensile strength, the yield strength and the elongation are measured according to ISO standard ISO 6892-1, published in October 2009. The tensile test specimens are cut-out from flat areas. If necessary, small size tensile test samples are taken to accommodate for the total available flat area on the part.

The bending angle is measured according to the VDA-238 bending standard. For the same material, the bending angle depends on the thickness. For the sake of simplicity, the bending angle values of the current invention refer to a thickness of 1.5 mm. If the thickness is different than 1.5 mm, the bending angle value needs to be normalized to 1.5 mm by the following calculation where α1.5 is the bending angle normalized at 1.5 mm, t is the thickness, and αt is the bending angle for thickness t:

α1.5=(αt×√t)/√1.5

Hot stamping is a forming technology for steel which involves heating a blank of steel, or a preformed part made from a blank of steel, up to a temperature at which the microstructure of the steel has at least partially transformed to austenite, forming the blank or preformed part at high temperature by stamping it and simultaneously quenching the formed part to obtain a microstructure having a very high strength, possibly with an additional partitioning or tempering step in the heat treatment.

A multistep hot stamping process is a particular type of hot stamping process including at least one stamping step and consisting of at least two process steps performed at high temperature, above 300° C. For example, a multistep process can involve a first stamping operation and a subsequent hot trimming operation, so that the finished part, at the exit of the hot stamping process, does not need to be further trimmed. For example, a multistep process can involve several successive stamping steps in order to manufacture parts having more complex shapes then what can be realized using a single stamping operation. For example, the parts are automatically transferred from one operation to another in a multistep process, for example using a transfer press. For example, the parts stay in the same tool, which is a multipurpose tool that can perform the different operations, such as a first stamping and a subsequent in-tool trimming operation.

The term “bottling” refers to the mode of deformation of a part subjected to a compressive load, typically a high slenderness part, where the part progressively absorbs the mechanical energy of the compressive load by forming a series of successive waves resulting from successive local buckling deformations of the part. As a result, the length of the part as measured in the direction of the compressive load is smaller after the deformation than the initial length of the part in said direction. In other words, when a part reacts to a compressive load by controlled buckling, it folds onto itself in the same way as a plastic bottle on which a compressive load is applied between the top and the bottom of the bottle.

### BRIEF DESCRIPTION OF THE DRAWINGS

FIG. 1 is a perspective view of an automotive vehicle having a front member assembly according to the invention,

FIG. 2 is a perspective view of the front part of an automotive vehicle according to the present invention,

FIG. 3 is an exploded perspective view of a front member assembly according to the reference design,

FIG. 4 is an exploded perspective view of a front member assembly according to an embodiment of the invention,

FIG. 5 is a perspective view of an assembled front member assembly according to the invention,

FIG. 6 is a top view of the lower shell according to a specific embodiment of the current invention.

### DETAILED DESCRIPTION

We will first describe the general conception of a fully assembled and mounted front member assembly, independently of the invention. The traditional or reference design of a front member assembly and of the individual parts making up said assembly will then be described. Finally, the innovative design according to the invention will be exposed.

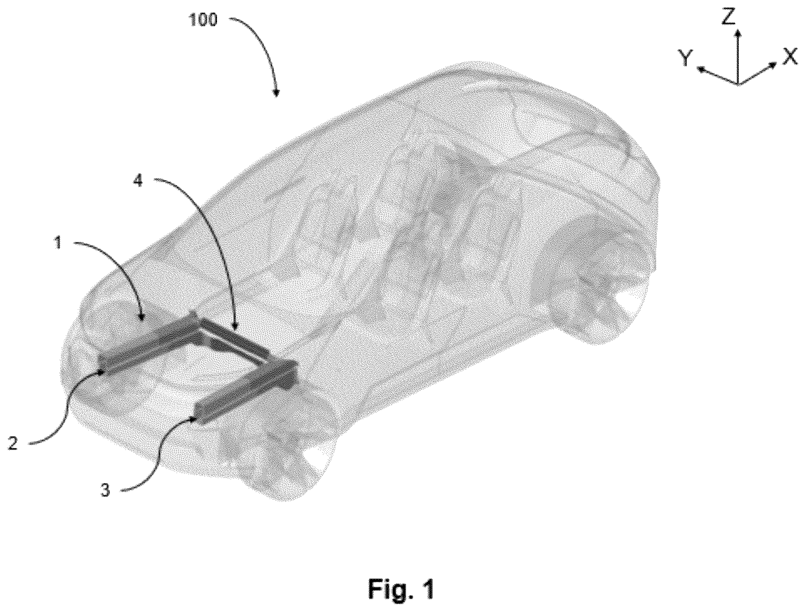

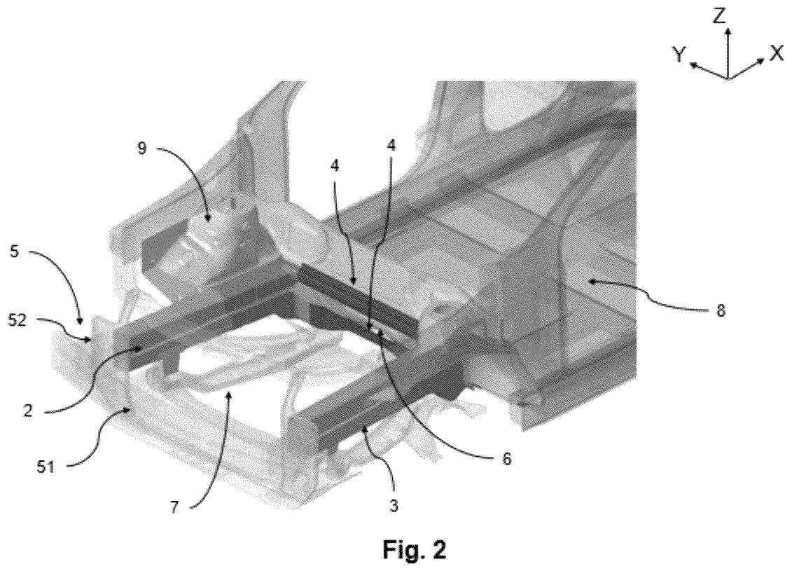

Referring to FIG. 1, the current invention focuses on the front member assembly 1 of a motor vehicle 100. Said front member assembly 1 comprises a right and a left front member 2, 3 and one or several dash panel cross members 4. Referring to FIG. 2, the front members 2, 3 are connected at their front, directly or indirectly (i.e. via intermediate connection parts) to a front bumper assembly 5. Said front bumper assembly 5 for example comprises a front bumper beam 51 and right and left crashboxes 52. The front bumper assembly 5 is the first element of the vehicle to hit the impactor in the case of a front crash. The front member assembly 1 acts to immediately pick up the crash energy from the front bumper assembly 5 and is therefore a key element of the front load path.

The dash panel cross members 4 are connected to the dash panel 6. The front members 2, 3 are further connected at their rear to the vehicles longitudinal crash management system, not represented in the figures. For example, the front members 2, 3 are connected to a rear front member, which typically has a double bend shape in its front portion allowing it to run at a lower elevation in its rear portion to fit underneath a floor panel 8 of the vehicle.

During a front crash, the front member assembly 1 will act to partially absorb the crash energy by plastic deformation and will also act to transmit the crash energy to the rest of the vehicle's structural elements while avoiding intrusion into the passenger compartment.

For example, the front members 2, 3 will partly absorb the crash energy, for example by plastic deformation, for example by bottling, on at least part of the front of said front members. For example, a rear portion of the front members 2, 3 and the dash panel crossmembers 4 will resist deformation and intrusion to protect the passengers of the vehicle and transmit the remaining crash energy to the rest of the vehicle's structural elements.

Further elements of the vehicle can be connected to the front member assembly. For example, it is usual practice in vehicle architectures to connect the front suspension elements 7 to the front members 2, 3. The connection of the front suspension to the body in white of the vehicle is also a key structural connection and an important one for safety, further reinforcing the key structural role of the front member assembly 1.

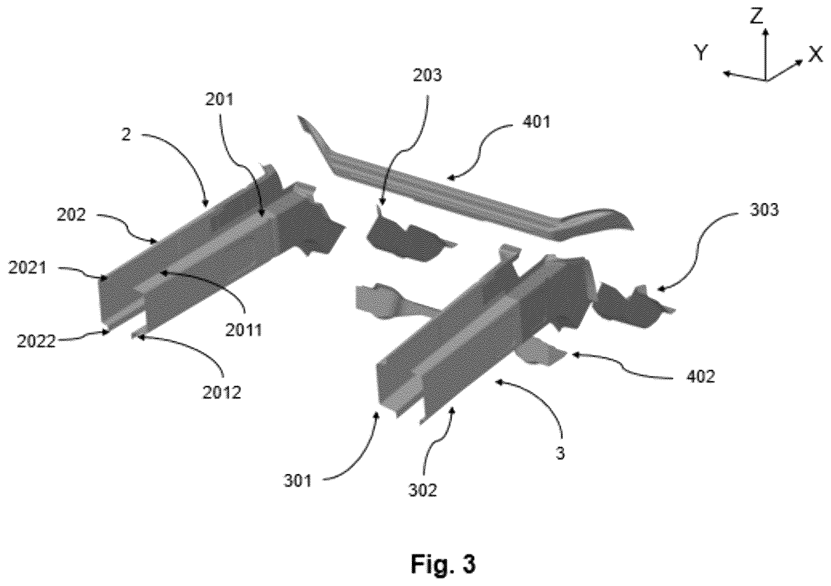

Referring to FIG. 3, an example of a reference design of the front assembly module 1 and the different sub parts making up said front member assembly will now be described. By reference design, it is meant a design according to the current design practices, as opposed to the inventive design, which will be subsequently described.

The right and left front members 2, 3 are made by assembling an inner 201, 301 and an outer 202, 302 front member along vertical flanges oriented along planes substantially parallel to the elevation and the longitudinal directions. Said flanges are labelled in the case of the right front member 2 only on FIG. 3 for clarity sake: the upper inner flange 2011 is assembled to the upper outer flange 2021, the lower inner flange 2012 is assembled to the lower outer flange 2022.

The reference front member assembly further comprises an upper and a lower dash panel cross-member 401, 402, which are designed to be attached to the dash panel 6 in order to reinforce it in case of a crash.

The reference front member assembly further comprises left and right front member extensions 203, 303, which are intermediate part between the front members 2, 3 and the rest of the vehicle structure at the rear of the front members.

The above described reference design of a front member assembly presents the major drawback that it consists of 8 different parts, which each need to be produced independently, with a specific tooling and which then need to be assembled together. The assembly of the different sub parts of the reference design is made by attaching the sub parts along planes which are oriented in vastly different directions. The flanges of the inner and outer front members are substantially vertically oriented in the longitudinal direction, the upper and lower dash panel cross members are assembled to the front members along a substantially transverse direction, the front rail extensions are assembled along an inclined direction between the horizontal and the vertical transverse direction. These diverging assembly planes makes it impossible to simplify the front member assembly design to reduce the number of parts.

Alongside the disadvantage of production complexity and high running costs, the use of many different parts to produce the front member assembly can also be a source of structural weakness. Indeed, the sub parts need to be assembled together using for example spot welding. The assembly points can be structural weaknesses due to the impact of the assembly process itself (for example, the presence of heat affected zones in the case of welding, which induces metallurgical transformations and potentially softer or fragile areas in or around the welds). The assembly points can also be sources of weaknesses when the assembly process is not correctly performed, which can happen in industrial conditions due to inevitable variations in the process, maintenance issues etc. The assembly points can therefore be areas in which cracks and failures occur during the running life of the vehicle or in the case of an accident.

The inventors have developed a fully redesigned front member assembly 1 which allows to reduce the number of parts from 8 sub parts in the reference design to only 2 sub parts. This reduces production complexity and the risk of structural weaknesses in the assembly points.

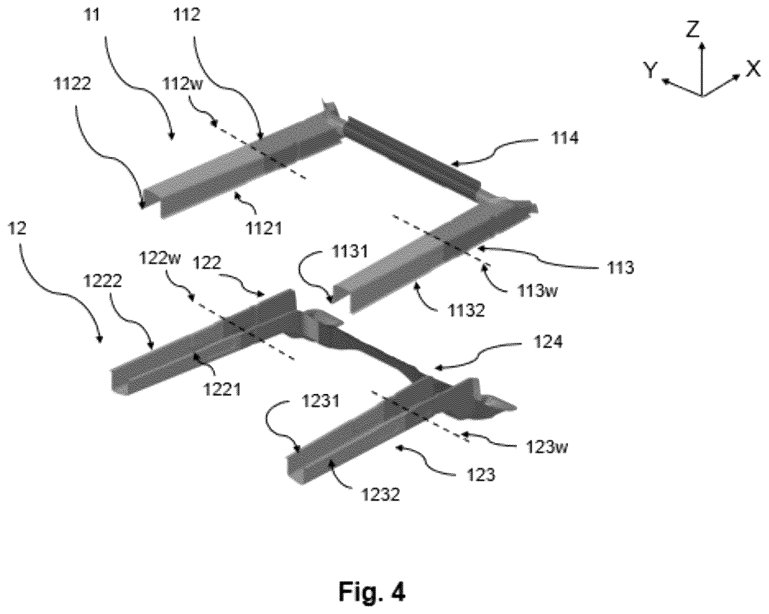

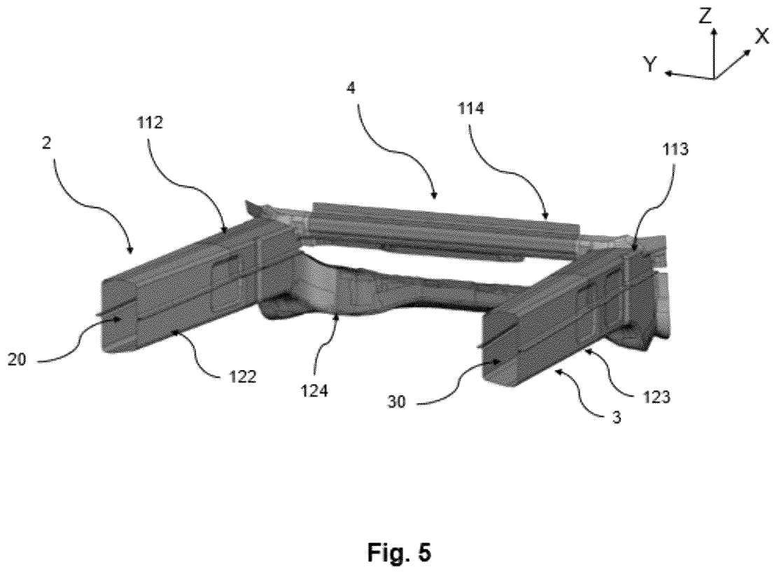

Referring to FIGS. 4 and 5 the front member assembly 1 according to the invention comprises an upper shell 11 and a lower shell 12. The upper shell 11 comprises a right portion 112 and a left portion 113 each extending in a substantially longitudinal direction. Said right and left portions 112, 113 are linked together by a transverse portion 114 extending substantially in a transverse direction and attached to said right and left portions at attachment points located at the rear of said portions. The lower shell 12 comprises a right portion 122 and a left portion 123 each extending in a substantially longitudinal direction. Said right and left portions 122, 123 are linked together by a transverse portion 124 extending substantially in a transverse direction and attached to said right and left portions at attachment points located at the rear of said portions.

Said upper and lower right portions 112, 122 define together a right hollow volume 20. Said upper and lower left portions 113, 123 define together a left hollow volume 30. (See FIG. 5). Said right and left hollow volumes 20, 30 extend from the front of the right and left portions to the attachment points of said right and left portions with their respective transverse portions 114, 124.

These hollow volumes 20,30 allow the front member assembly to withstand a frontal crash energy, to partially absorb it by plastic deformation and to resist intrusion and transmit the energy to the rest of the structure.

The upper shell right portion 112 comprises a lower contour inner and outer 1121 and 1122 extending over the lower extremity of said upper shell right portion respectively on the inner side and outer side of said right portion. This lower contour can for example be a straight or curvilinear line. This lower contour can for example take the form of flanges, as illustrated on FIGS. 4 and 5. In a similar fashion, the upper shell left portion 113 comprises a lower contour inner and outer 1131 and 1132, the lower shell right portion 122 comprises an upper contour inner and outer 1221 and 1222 and the lower shell left portion 123 comprises un upper contour inner and outer 1231 and 1232.

The corresponding upper and lower shell contours have complementary shapes so that they fit in with one another when the upper and lower shells 11, 12 are brought together when assembling the front member assembly. More specifically, the upper shell right portion lower contour inner 1121 has a complementary shape to the lower shell right portion upper contour inner 1221, the upper shell right portion lower contour outer 1122 has a complementary shape to the lower shell right portion upper contour outer 1222, the upper shell left portion lower contour inner 1131 has a complementary shape to the lower shell left portion upper contour inner 1231 and the upper shell left portion lower contour outer 1132 has a complementary shape to the lower shell left portion upper contour outer 1232. The upper and lower shells are assembled by attaching them together at least along part of said upper and lower left and right inner and outer contours.

Thanks to the above described design, it is possible to assemble the entire front member assembly using only two parts, the top and bottom shells 11, 12. This greatly simplifies production and logistics. It also reduces the amount of assembly points, which are limited to the upper and lower contours of the right and left portions, which limits the amount of structural weaknesses induced by the assembly and therefore allows to produce a more robust front member assembly 1.

Furthermore, the front member assembly 1 according to the invention is well suited to serve as stand alone assembly base for the entire front module of the vehicle. Referring to FIG. 2, for example, the bumper assembly 5 and the wheelhouses 9 can be attached to the front member assembly 1 to form a stand-alone front module unit which can then be directly carted into the rest of the body in white in the final vehicle assembly plant. Further elements which can be integrated to the front module are possibly suspension elements 7. Producing such a stand-alone front module can greatly simplify the assembly sequence in the final vehicle assembly plant. The front member assembly according to the invention is particularly suited to this type of practice because it is a fully rigid and integrated structure in both the longitudinal and transverse directions. This fully rigid longitudinal and transverse structure allows to tie together all the different parts making up the front module. Furthermore, the design according to the invention also allows to easily provide for assembly areas with other parts within the front member assembly 1.

The following is a description of specific embodiments of the above described invention, which can be implemented individually or according to any possible combination.

In a specific embodiment, the upper and lower shells 11, 12 are attached along their respective upper and lower contours by welding, for example by MIG or MAG welding.

In a specific embodiment, represented on FIGS. 4 and 5, the upper and lower contours of the right and left upper and lower portions consist of flat flanges. Advantageously, this makes it possible to attach them together by resistance spot welding. It also makes it possible to assemble them by laser welding, for example by remote laser welding, for example by forming laser stitches, which are short laser welds having a shape well suited to the attachment function and reproduced along the length of the flanges.

In a specific embodiment, the front member assembly 1 further comprises bulkheads within the hollow volumes 20, 30, in order to further increase the resistance in case of a frontal crash. Bulkheads are generally flat plates extending in a generally horizontal plane and assembled to the right and left portions, for example by spot welding or by MIG/MAG welding.

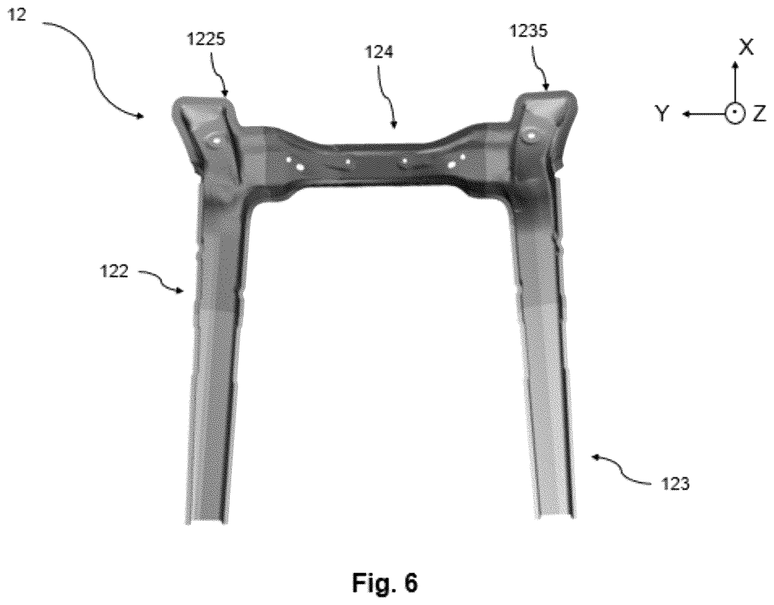

In a specific embodiment, represented on FIG. 6, the lower shell 12 further comprises at its rear end left and right rear extensions 1225, 1235 extending backwards further back than the lower shell transverse portion 124. For example, as depicted on FIG. 6, said rear extensions 1225, 1235 splay outwards in order to serve as attachment points to the longitudinal members located underneath the floor panel. In fact, the inward slant from front to back of the right and left portions 122, 123 coupled with the outward splay of the rear extensions 1225, 1235, which is depicted on FIG. 6 allows to optimize the width of the front member assembly 1 at the front and pick up the rest of the vehicle's structural longitudinal members at the rear while making enough room for the wheels and the wheelhouses 9 on the outer sides of the of the front member assembly towards the transverse portion 4.

In a specific embodiment, the upper and lower shells 11, 12 are each made by forming a single metallic sheet. Advantageously this allows to further reduce the number of material handling and stamping operations. Using a single metal sheet to produce the upper and lower shells also ensures an optimal collaboration between all the portions of said shells and therefore an optimal performance for example when resisting to a front crash. In particular, it ensures an optimal collaboration between the left portions and the transverse portions and also between the right portions and the transverse portions. This type of collaboration is particularly important in the case of small overlap front impacts, in which one side will pick up a great part of the crash energy, which will be partially transmitted to the other side and to the rest of the vehicle structure thanks to the collaboration with the transverse portions.

In a specific embodiment, the upper and lower shells are each made by forming a single metallic sheet consisting of a tailor welded blank, for example using steel sheets sub blanks for the tailor welded blanks. Advantageously, this allows to optimally distribute the material grade and the material thickness in the different areas of the upper and lower shells according to the desired performance and behavior of each area. This also allows to optimize and reduce the scrap involved in producing the upper and lower shells. Indeed, the upper and lower shells have a U-shaped design-this entails cutting out a high amount of scrap in the inside of the U-shape if the parts are made using monolithic blanks. On the other hand, when using several sub-blanks combined in tailor welded blanks it is possible to use substantially rectangular sub-blanks for the left, right and transverse portions, which means that very little scrap is generated. The inventors have also found that by using a single metal sheet made from laser welded blanks for the upper and lower shells, the improved collaboration between the different portions of the front member assembly and the significant reduction of overlap areas to assemble the individual parts together leads to a significant weight reduction, in the order of 15% to 20%.

In a specific embodiment, the blanks or sub-blanks used to manufacture the upper and lower shells comprise tailor rolled blanks.

In a specific embodiment, the upper and lower shells 11, 12 further comprise a deformable portion extending over a front part of the right and left portions 112, 122, 113, 123 of said shells and a non-deformable portion extending over a rear part of the right and left portions and over at least part of the transverse portions 114, 124 of said shells. The resistance to plastic deformation of said deformable portions is lower than the resistance to plastic deformation of said non-deformable portions. For example, the product of the tensile strength by the average thickness of said deformable portions is lower than the product of the tensile strength by the average thickness of said non-deformable portions. Advantageously, in the case of a front impact, this allows to manufacture a front member assembly 1 having a front part corresponding to the deformable portions, close to the bumper assembly 5 and furthest away from the passenger compartment, which will undergo plastic deformation, for example by bottling, thus absorbing part of the crash energy. At the same time, the non-deformable portion of the front member assembly, located at the rear, thus closest to the passenger compartment, will resist intrusion, thus protecting the passengers and also transmitting the remaining energy of the impact to the rest of the vehicle structure.

In a specific embodiment, the above described deformable portions are obtained by manufacturing the upper and lower shells using tailor welded blanks and by using a material having a lower resistance to plastic deformation at the front of the left and right portions than the material used at the back of said right and left portions and for the transverse portions. For example, the product of the tensile strength by the average thickness of said deformable portions is lower than the product of the tensile strength by the average thickness of said non-deformable portions. FIG. 4 represents an example of such an embodiment in which the weld lines delimiting the material of the deformable and non-deformable portions are schematically represented by the dotted lines 112w, 113w, 122w and 123w.

In a specific embodiment, the upper and lower shells are each made by forming a single metallic sheet, possibly consisting of a tailor welded blank, and are manufactured using hot stamping. Advantageously, this allows to produce very high strength parts having a complex shape and without any springback issues. When using tailor welded blanks, this also allows to eliminate the impact of the assembly process of the sub-blanks on the properties of the final part, because the assembly points, for example the laser welds or spot welds, undergo a metallurgical transformation during the hot stamping process.

In a specific embodiment at least one of the upper and lower shells is made by multistep hot stamping. Advantageously, this allows to produce even more complex shapes while guaranteeing very high mechanical properties to the part.

In a specific embodiment at least one of the upper and lower shells are made by hot stamping and the blanks used to produce it comprise one of the following materials, either in the form of monolithic blanks or combined in the form of tailor welded blanks:
Steel having a composition comprising in % weight: 0.06%≤C≤0.1%, 1%≤Mn≤2%, Si≤0.5%, Al≤0.1%, 0.02%≤Cr≤0.1%, 0.02%≤Nb≤0.1%, 0.0003%≤B≤0.01%, N≤0.01%, S≤0.003%, P≤0.020% less than 0.1% of Cu, Ni and Mo, the remainder being iron and unavoidable impurities resulting from the elaboration. With this composition range, the yield strength of the corresponding area after hot stamping is comprised between 700 and 950 MPa, the tensile strength between 950 MPa and 1200 MPa and the bending angle is above 75°. For example, this material is used in the deformable portions of the front member assembly 1, because its high bending angle combined with high mechanical properties allows it to absorb a high amount of crash energy, for example by bottling.
Steel having an ultimate tensile strength after hot stamping which is comprised between 1300 MPa and 1650 MPa and a yield strength which is comprised between 950 MPa and 1250 MPa.
Steel having an ultimate tensile strength after hot stamping which is comprised between 1300 MPa and 1650 MPa, a yield strength which is comprised between 950 MPa and 1250 MPa and a bending angle which is above 75°.
Steel having a composition comprising in % weight: 0.20%≤C≤0.25%, 1.1%≤Mn≤1.4%, 0.15%≤Si≤0.35%, Cr≤0.30%, 0.020%≤Ti≤0.060%, 0.020%≤Al≤0.060%, S≤0.005%, P≤0.025%, 0.002%≤B≤0.004%, the remainder being iron and unavoidable impurities resulting from the elaboration. With this composition range, the ultimate tensile strength of the corresponding area of the part after hot stamping is comprised between 1300 MPa and 1650 MPa and the yield strength is comprised between 950 MPa and 1250 MPa. For example, this steel composition is used for the non-deformable portion of the front member assembly because it allows to resist intrusion thanks to its high mechanical properties.
Steel having a tensile strength after press-hardening higher than 1800 MPa.
Steel having a composition which comprises in % weight: 0.24%≤C≤0.38%, 0.40%≤Mn≤3%, 0.10%≤Si≤0.70%, 0.015%≤Al≤0.070%, Cr≤2%, 0.25%≤Ni≤2%, 0.015%≤Ti≤0.10%, Nb≤0.060%, 0.0005%≤B≤0.0040%, 0.003%≤N≤0.010%, S≤0.005%, P≤0.025%, %, the remainder being iron and unavoidable impurities resulting from the elaboration. With this composition range, the tensile strength of the corresponding area of the front member assembly after hot stamping is higher than 1800 MPa. For example, this material is used in the non-deformable area.
Steel having a composition which comprises in % weight: C: 0.15-0.25%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Mo≤0.40%, Nb≤0.08%, Ca≤0.1%, the remainder of the composition being iron and unavoidable impurities resulting from the smelting. With this composition range, the tensile strength of the corresponding area of the front member assembly after hot stamping is higher than 1350 MPa and the bending angle is higher than 70°.
Steel having a composition which comprises in % weight: C: 0.26-0.40%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Ni≤0.5%, Mo≤0.40%, Nb≤0.08%, Ca≤0.1% the remainder of the composition being iron and unavoidable impurities resulting from the smelting. With this composition range, the tensile strength of the corresponding area of the front member assembly after hot stamping is higher than 1500 MPa and the bending angle is higher than 70°.
Steel having a composition which comprises in % weight: C: 0.2-0.34%, Mn: 0.50-1.24%, Si: 0.5-2%, P≤0.020%, S≤0.010%, N≤0.010%, and comprising optionally one or more of the following elements, by weight percent: Al: ≤0.2%, Cr≤0.8%, Nb≤0.06%, Ti≤0.06%, B≤0.005%, Mo≤0.35%, the remainder of the composition being iron and unavoidable impurities resulting from the smelting. With this composition range, the tensile strength of the corresponding area of the front member assembly after hot stamping is equal to or higher than 1000 MPa and the bending angle is higher than 55°.
Steel having a composition which comprises in % weight: C: 0.13-0.4%, Mn: 0.4-4.2%, Si: 0.1-2.5%, Cr≤2%, Mo≤0.65%, Nb≤0.1%, Al≤3.0%, Ti≤0.1%, B≤0.005%, P≤0.025%, S≤0.01%, N≤0.01%, Ni≤2.0%, Ca≤0.1%, W≤0.30%, V≤0.1%, Cu≤0.2%, and verifying the following combination: 114-68*C-18*Mn+20*Si-56*Cr-60*Ni-36*Al+38*Mo+79*Nb-17691*B<20, the remainder of the composition being iron and unavoidable impurities resulting from the smelting. For example, this composition is used when hot stamping the part using a multistep process.
Steel which is coated with an aluminum-based metallic coating. By aluminum based it is meant a coating that comprises at least 50% of aluminum in weight. For example, the metallic coating is an aluminum-based coating comprising 8-12% in weight of Si. For example, the metallic coating is applied by dipping the base material in a molten metallic bath. Advantageously, applying an aluminum-based metallic coating avoids the formation of surface scale during the heating step of the hot stamping process, which in turns allows to produce the parts by hot stamping without a subsequent sand blasting operation. Furthermore, the aluminum-based coating also provides corrosion protection to the part while in service on the vehicle.
Steel which is coated with an aluminum-based metallic coating comprising from 2.0 to 24.0% by weight of zinc, from 1.1 to 12.0% by weight of silicon, optionally from 0 to 8.0% by weight of magnesium, and optionally additional elements chosen from Pb, Ni, Zr, or Hf, the content by weight of each additional element being inferior to 0.3% by weight, the balance being aluminum and optionally unavoidable impurities. Advantageously, this type of metallic coating affords very good corrosion protection on the part, as well as a good surface aspect after hot stamping.

In a specific embodiment, at least the upper or lower shell is made by hot stamping a laser welded blank comprising at least one sub blank having an aluminum based metallic coating and said aluminum coated sub-blanks are prepared before-hand by ablating at least part of the metallic coating on the edges to be welded. Advantageously, this removes part of the aluminum present in the coating, which would pollute the weld seam and deteriorate its mechanical properties.

In a particular embodiment, at least the upper or lower shell is made by hot stamping a laser welded blank comprising at least one sub blank having at least one side topped with an emissivity increasing top layer. Said emissivity increasing top layer is applied on the outermost surface of said sub-blank. Said emissivity increasing top layer allows the surface of said sub blank to have a higher emissivity compared to the same sub-blank which is not coated with said emissivity increasing top layer. Said emissivity increasing top layer can be applied either on the top or the bottom side of a sub-blank. Said emissivity increasing top layer can also be applied on both sides of said sub-blank. If said sub-blank comprises a metallic coating, such as described previously, the emissivity increasing top layer is applied on top of said metallic coating. Indeed, for the emissivity increasing top layer to increase the emissivity of the surface, it needs to cover the outermost surface of the sub-blank. Advantageously, said emissivity increasing top layer will allow to increase the heating rate of said sub-blank and therefore increase the productivity of the heating step of the hot stamping process. When using several sub blanks of differing thicknesses, said emissivity increasing top layer is advantageously applied to the sub-blanks having the highest thickness in order to decrease the difference in heating time between the different sub-blanks and therefore increase productivity, increase the hot stamping process window and overall allow to obtain a final part having homogeneous surface properties.

What is claimed is:

1-8. (canceled)

9: A front member assembly for an automotive vehicle comprising:
an upper shell and a lower shell, each comprising respectively a right portion and a left portion extending substantially in a longitudinal direction, each of the right and left portions being linked together by a transverse portion extending substantially in a transverse direction between attachment points located at a rear of the left and right portions, the upper and lower right portions defining together a right hollow volume, the upper and lower left portions defining together a left hollow volume, the right and left hollow volumes extending from a front of the right and left portions to the attachment point of the right and left portions with the respective transverse portions, the upper right and left portions being delimited by a lower contour inner and outer, the lower right and left portion being delimited by an upper contour inner and outer, wherein the upper and lower shells are assembled together by attachment at least along part of the corresponding lower and upper contours.

10: The front member assembly as recited in claim 9 wherein the upper and lower contours are flat flanges and wherein the upper and lower shells are assembled together by attachment along the flanges.

11: The front member assembly as recited in claim 9 wherein the upper and lower shells are each made by forming a single metallic sheet.

12: The front member assembly as recited in claim 9 wherein the upper and lower shells are each made by forming a single tailor welded blank by hot stamping.

13: The front member assembly as recited in claim 9 wherein the upper and lower shells each comprise a deformable portion extending over a front part of the right and left portions of said shells and a non-deformable portion extending over a rear part of the right and left portions of the upper and lower shells and over at least part of the transverse portions of the upper and lower shells, wherein resistance to plastic deformation of the deformable portions is lower than the resistance to plastic deformation of the non-deformable portions.

14: An automotive vehicle comprising the front member assembly as recited in claim 9.

15: The automotive vehicle as recited in claim 14 wherein the front member assembly is assembled to a front bumper assembly.

16: The automotive vehicle as recited in claim 14 wherein the front member assembly is assembled to a dash panel.
